(19) United States
(12) Patent Application Publication
(10) Pub. No.: US 2024/0174029 A1
(43) Pub. Date: May 30, 2024

(54) TIRE

(71) Applicant: Sumitomo Rubber Industries, Ltd., Kobe-shi (JP)

(72) Inventors: Kosuke MIYOSHI, Kobe-shi (JP); Yuto HASHIMOTO, Kobe-shi (JP); Sho NAKAJIMA, Kobe-shi (JP); Ryuhei SANAE, Kobe-shi (JP)

(73) Assignee: Sumitomo Rubber Industries, Ltd., Kobe-shi (JP)

(21) Appl. No.: 18/385,045

(22) Filed: Oct. 30, 2023

(30) Foreign Application Priority Data
Nov. 24, 2022 (JP) 2022-187523

(51) Int. Cl. B60C 11/12; B60C 11/03

(52) U.S. Cl. CPC B60C 11/1281; B60C 11/0306; B60C 11/1263; B60C 2011/0341; B60C 2011/0358; B60C 2011/1213

(57) ABSTRACT

A tire comprises a tread portion provided with a first block provided with a first sipe which extends zigzag in a cross section orthogonal to the sipe length direction, and extends zigzag in a cross section parallel to the ground contacting top surface of the first block. The first sipe is divided into a first portion and a second portion by a tie bar. The sipe bottom in the first portion communicates with a first wide portion. The sipe bottom in the second portion communicates with a second wide portion. The first wide portion comprises an outer portion and an inner portion. The outer portion is formed by a pair of first arcuate groove wall portions. The inner portion is formed by a pair of second arcuate groove wall portions. The first wide portion and the second wide portion do not communicate with each other.

### TECHNICAL FIELD

The present disclosure relates to a tire.

### BACKGROUND ART

Patent Document 1 below discloses a pneumatic tire intended for use in the winter season. In this tire, an outside shoulder land portion is divided into a plurality of outside shoulder blocks by a plurality of outside shoulder lateral grooves extending in the tire axial direction. The outside shoulder block is divided by a narrow groove extending in the tire circumferential direction into a first block piece on the outside tread edge side and a second block piece on the inside tread edge side. The first block piece is provided with first sipes, and the second block piece is provided with second sipes. The total number of the second sipes of the second block piece is greater than the total number of the first sipes of the first block piece.
Patent Document 1: Japanese Patent Application Publication No. 2021-195051

### SUMMARY OF THE INVENTION

### Problems to be Solved by the Invention

In recent years, winter tires provide with a large number of sipes in land portions are required to have further improved on-ice performance.

In such a siped tire, the bottom of the sipe is likely to be distorted by the collapse of the land portion due to the load applied when the land portion contacts with the ground. As a result, cracks starting from the sipe bottom are likely to occur.

Thus, such tire is required to be improved in durability of the bottom portion of the sipe against a load when contacting with the ground (hereinafter referred to as the “loading durability”).

On the other hand, in the case of siped tires, it is also necessary to ensure mold releasability during vulcanization molding (namely, easiness of demolding a tire from the vulcanization mold).

In view of the above circumstances, the present disclosure was made, and a primary objective thereof is to provide a tire with improved on-ice performance and loading durability while ensuring mold releasability.

### Means for Solving the Problems

According to the present disclosure, a tire comprises a tread portion provided with a plurality of circumferential grooves extending continuously in a tire circumferential direction, a plurality of lateral grooves extending in a tire axial direction, and a plurality of first blocks,

wherein
each of the first blocks is provide with at least one first sipe which extends zigzag in its cross section perpendicular to the length direction thereof, and extends zigzag in a cross-section parallel with the ground contacting top surface of the first block,
each of the first sipes is provided with at least one tie bar which is locally raised outward in a tire radial direction from the sipe bottom, and terminated without reaching the ground contacting top surface of the first block so that the first sipe is partially divided in the length direction of the sipe by the above-said at least one tie bar into at least a first portion and a second portion,
in each of the first sipes, the sipe bottom of the first portion communicates with a first wide portion having a groove width larger than the sipe width of the first portion, and the sipe bottom of the second portion communicates with a second wide portion having a groove width larger than the sipe width of the second portion,
the above-said first wide portion comprises, in its cross section,
   an outer portion in the tire radial direction formed by a pair of first arcuate groove wall portions each convex toward a center line of the first sipe so that the groove width continuously increases from the sipe bottom toward the inner side in the tire radial direction, and
   an inner portion in the tire radial direction formed by a pair of second arcuate groove wall portions each convex toward the opposite side to the center line of the first sipe so that the groove width continuously decreases inward in the tire radial direction to the bottom of the first wide portion, and
the first wide portion and the second wide portion do not communicate with each other.

### Effects of the Invention

In the present disclosure, therefore, the tire can be improved in on-ice performance and the loading durability, while ensuring the mold releasability.

### BRIEF DESCRIPTION OF THE DRAWINGS

FIG. 1 is a developed partial view of a tread portion of a tire as an embodiment of the present disclosure.

FIG. 2 is a cross-sectional view of the tread portion of FIG. 1.

FIG. 3 is an enlarged view showing tow of first blocks in FIG. 1.

FIG. 4 is an enlarged perspective view conceptually showing the interior space of the first sipe.

FIG. 5 is a cross-sectional view taken along line AA of FIG. 3.

FIG. 6 is a cross-sectional view of the first sipe shown in FIG. 3 taken along a plane parallel to the ground contacting top surface of the first block.

FIG. 7 is a cross-sectional view taken along line BB of FIG. 3.

FIG. 8 is an enlarged view of the first wide portion in FIG. 5.

FIG. 9 is an enlarged cross-sectional view of the second wide portion taken along line CC of FIG. 3.

### DETAILED DESCRIPTION OF THE INVENTION

An embodiment of the present disclosure will now be described in detail in conjunction with accompanying drawings.

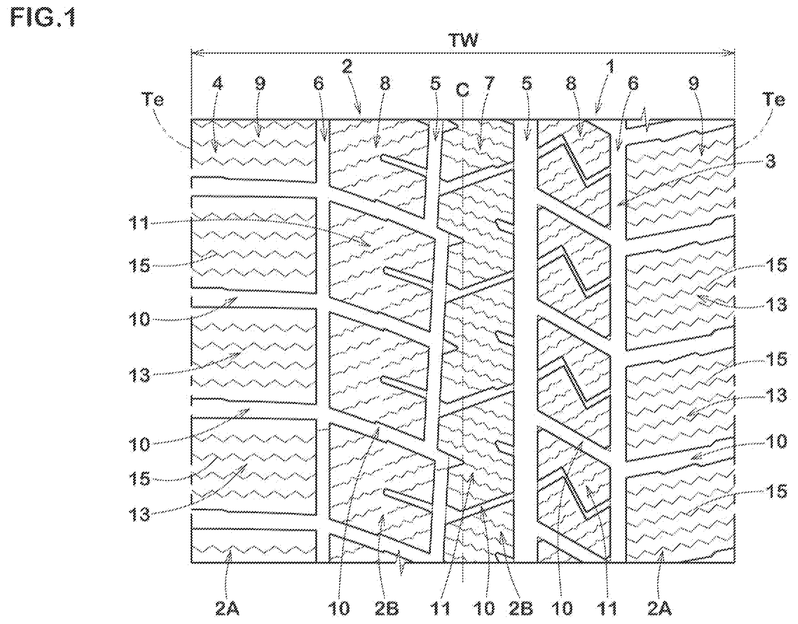

FIG. 1 is a developed partial view of a tread portion 2 of a tire 1 as an embodiment of the present disclosure.

The tire 1 of the present disclosure shown in FIG. 1 is intended for use in winter.

In the present embodiment, the tire 1 is designed as a pneumatic tire for passenger cars.

The present disclosure is however, not limited to such pneumatic tire, and may be applied, for example, to heavy duty tires.

The tread portion 2 comprises a plurality of circumferential grooves 3 continuously extending in the tire circumferential direction between two tread edges Te, and a plurality of land portions 4 axially divided by these circumferential grooves 3.

The tread edge Te corresponds to the outermost contact position in the tire axial direction when the tire 1 in its normal state is contact with a flat horizontal surface at a camber angle of 0 degrees and loaded with 70% of a normal load therefor.

In the case of pneumatic tires for which various standards have been established, the “normal state” is a state of a tire in which the tire is mounted on a regular rim, inflated to a normal internal pressure, and loaded with no tire load.

In the case of tires or non-pneumatic tires for which various standards are not defined, the “normal state” means a standard usage state according to the purpose of use of the tire, and a state in which the tire is not mounted on the vehicle and no load is applied.

In this specification, unless otherwise noted, dimensions, positions and the like of each part or portion of the tire refer to those under the normal state.

In addition, in the present specification, known methods can be appropriately applied to the method for measuring the dimensions, positions and the like unless otherwise noted.

The “regular rim” means a wheel rim specified for the tire by a standard system including standards on which the tire is based, for example, “Standard Rim” in JATMA, “Design Rim” in TRA and “Measuring Rim” in ETRTO.

The “normal internal pressure” is the air pressure specified for the tire by a standard system including standards on which the tire is based, for example, the maximum air pressure in JATMA, the maximum value listed in the table “TIRE LOAD LIMITS AT VARIOUS COLD INFLATION PRESSURES” in TRA, and the “Inflation Pressure” in ETRTO.

In the case of a pneumatic tire for which various standards have been established, the “normal load” is a tire load specified for the tire by a standard system including standards on which the tire is based, for extreme, the maximum load capacity in JATMA, the maximum value listed in the table “TIRE LOAD LIMITS AT VARIOUS COLD INFLATION PRESSURES” in TRA, and the load capacity in ETRTO.

In the case of a tire for which various standards have not yet been established, the “normal load” is the maximum load which can be applied to the tire when used.

The tread portion 2 in the present embodiment is provided with four circumferential grooves 3: two crown circumferential grooves 5 and two shoulder circumferential grooves 6.

The two crown circumferential grooves 5 are arranged so as to sandwich the tire equator C.

The two shoulder circumferential grooves 6 are arranged so as to sandwich the two crown circumferential grooves 5.

The present disclosure is however, not limited to such groove arrangement.

For the circumferential grooves 3, various mode, for example, straight grooves, zigzag grooves and the like may be adopted.

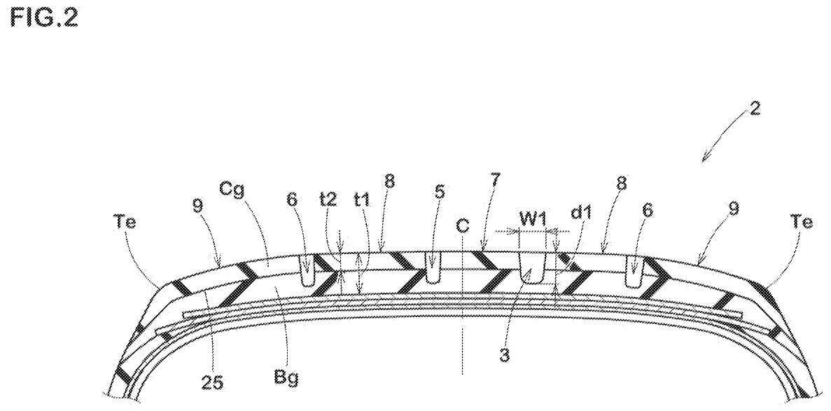

FIG. 2 conceptually shows a cross section of the tread portion 2, and cross sections of sipes and lateral grooves observed in a plan view of the tread portion 2 are omitted in FIG. 2.

As shown in FIG. 2, the groove widths of the circumferential grooves 3 are preferably at least 3 mm.

The maximum groove width W1 among the circumferential grooves 3 is, for example, 2.0% to 5.0% of the tread width TW (shown in FIG. 1).

The maximum depth d1 among the circumferential grooves 3 is, for example, 5 to 15 mm.

The tread width TW corresponds to the distance in the tire axial direction from one tread edge Te to the other tread edge Te under the normal state.

As shown in FIG. 1, by the four circumferential grooves 3, the tread portion 2 in the present embodiment is axially divided into five land portions 4: one crown land portion 7, two middle land portions 8, and two shoulder land portions 9.

The crown land portion 7 is defined between the two crown circumferential grooves 5.

Each of the middle land portion 8 is defined between one of the two crown circumferential groove 5 and one of the two shoulder circumferential groove 6.

Each of the shoulder land portion 9 is defined between one of the shoulder circumferential grooves 6 and the adjacent tread edge Te.

The tread portion 2 in the present embodiment is provided with a plurality of lateral grooves 10.

By the lateral grooves 10, each of the land portions 4 is circumferentially divided into a row of plurality of blocks 11.

The blocks 11 include first blocks 13 in the shoulder land portions 9 forming the tread edges Te.

Each of the first blocks 13 is provided with at least one first sipe 15.

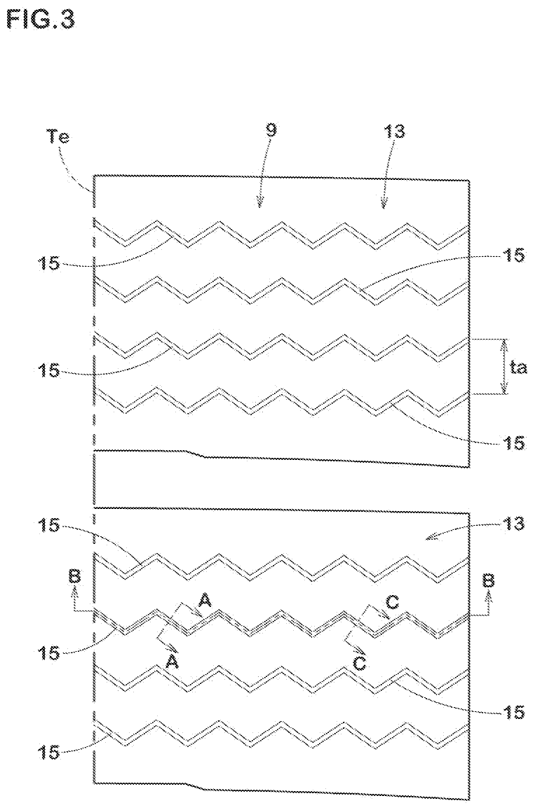

In the present embodiment, each of the first blocks 13 is provided with a plurality of first sipes 15 as shown in FIG. 3 which shows, for example, two of the circumferentially adjacent first blocks 13 in the shoulder land portion 9 on the left side of FIG. 1.

The term “sipe” refers to means a narrow groove having a width not more than 1.5 mm between two opposite inner walls inclusive of a cut having no substantial width.

Such a sipe however, may be provided with a chamfer at one of or each of the opening edges.

In the present embodiment, at the bottom of the first sipe 15, the first sipe 15 communicates with a wide portion as described later.

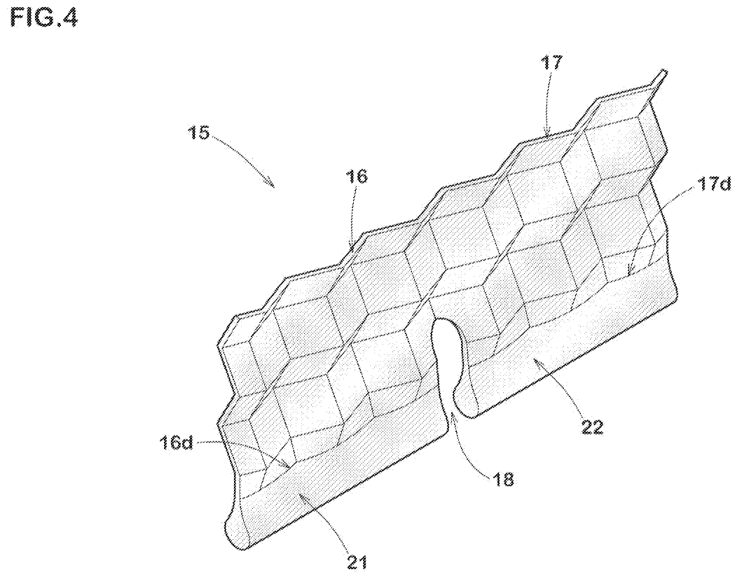

FIG. 4 conceptually shows the interior space of the first sipe 15, wherein the interior space is lightly dotted.

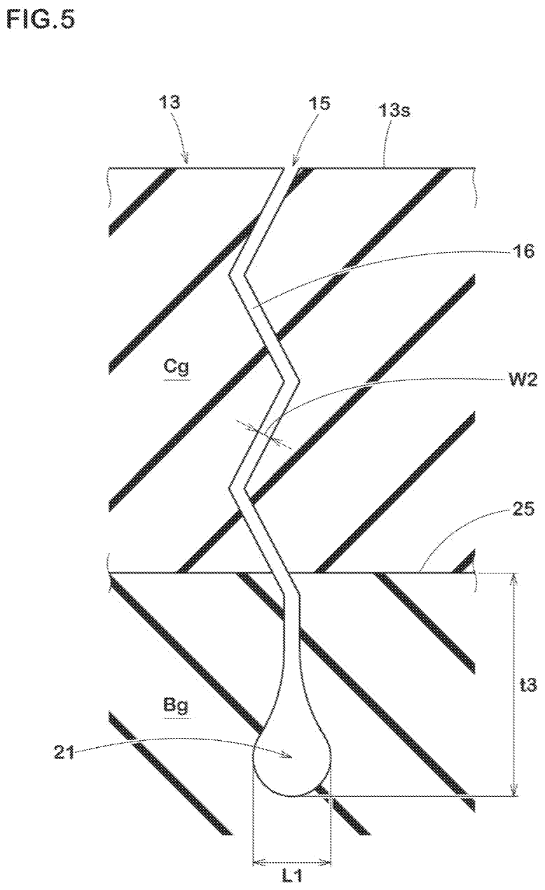

FIG. 5 shows a cross section of the first sipe 15 and a cross section of a first wide portion 21 taken orthogonal to the sipe length direction, corresponding to a cross-sectional view taken along line AA in FIG. 3.

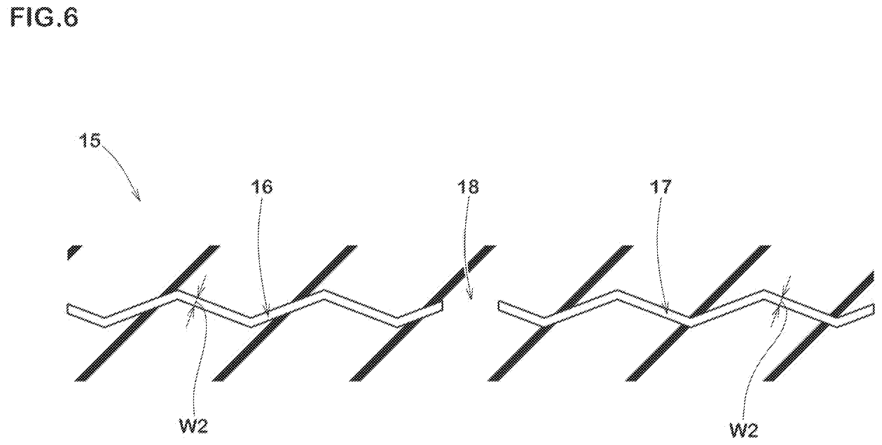

FIG. 6 shows a cross section of the first sipe shown in FIG. 3 taken along a plane parallel to the ground contacting top surface of the first block 13.

As shown in FIGS. 4 to 6, the first sipe 15 in the present embodiment extends in a zigzag shape in a cross section orthogonal to the sipe length direction, and extends in a zigzag shape in a cross section parallel to the ground contacting top surface of the first block 13.

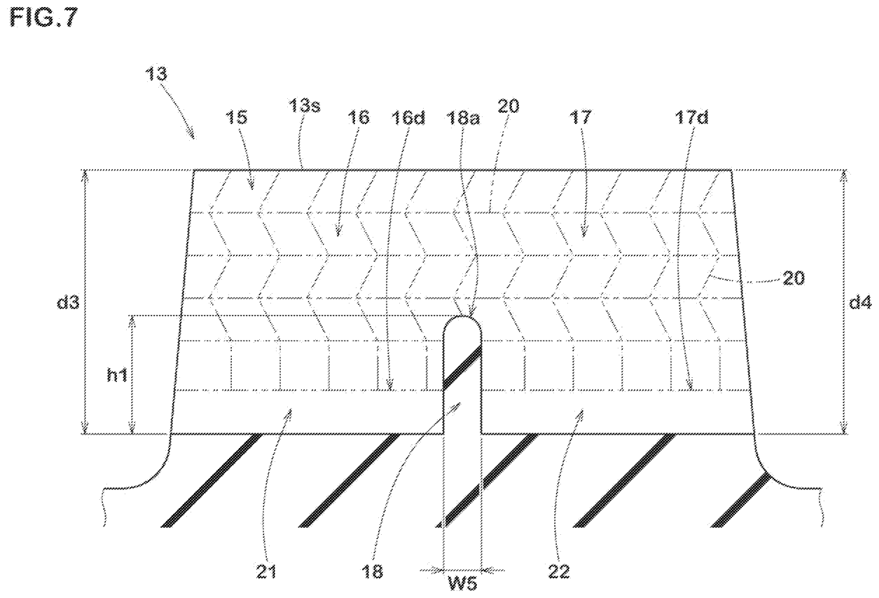

FIG. 7 shows a cross section of the first sipe 15 taken along its length direction, corresponding to a cross-sectional view taken along line BB of FIG. 3.

In FIG. 7, ridge and valley lines 20 partitioning convexes and concaves formed in the two opposite inner walls are shown by two-dot chain lines.

As shown in FIG. 7, the first sipe 15 is provided with at least one tie bar 18, and thereby partially divided (near the bottom) in the length direction of the sipe into at least a first portion 16 and a second portion 17.

The tie bar 18 locally protrudes outward in a tire radial direction from the sipe bottom (in this example, from the bottoms of the wide portions 21 and 22) and terminates without reaching the ground contacting top surface 13s of the first block 13.

By an imaginary line (not shown) obtained by radially outwardly extending the center line in the sipe length direction of the tie bar 18, the portion of the first sipe 15 between the radially outer end of the tie bar 18 and the ground contacting top surface 13s of the first block 13, is virtually divided into two portions which is explained hereunder as being included in the first portion 16 and the second portion, respectively.

As shown in FIG. 4, the first wide portion 21 communicates with the sipe bottom 16d of the first portion 16.

As shown in FIG. 5, the first wide portion 21 has a groove width larger than the sipe width in the first portion 16.

Further, as shown in FIG. 4, a second wide portion 22 communicates with the sipe bottom 17d of the second portion 17.

The second wide portion 22 has a groove width larger than the sipe width in the second portion 17.

In the present embodiment, unless otherwise noted, the configuration of the first wide portion 21 can be applied to the second wide portion 22.

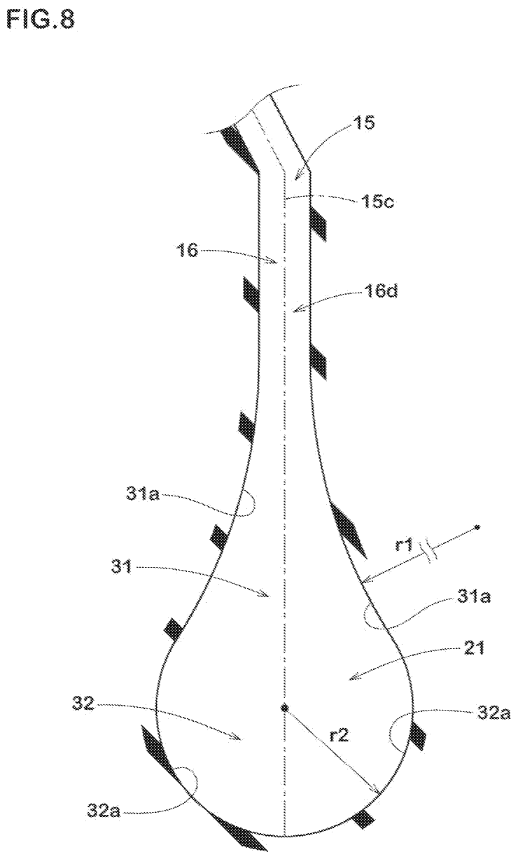

FIG. 8 is an enlarged cross-sectional view of the first wide portion 21 shown in FIG. 5.

As shown in FIG. 8, the first wide portion 21 comprises an outer portion 31 in the tire radial direction and an inner portion 32 in the tire radial direction at least.

Further, in the cross-sectional view of the first wide portion 21, the outer portion 31 is formed by a pair of opposite first arcuate groove wall portions 31a which are convex toward a center line 15c of the first sipe 15 so that the groove width of the outer portion 31 continuously increases inward in the tire radial direction from the sipe bottom 16d of the first portion 16.

The center line 15c is a center line in the width direction of the first sipe 15 which is extended to the bottom of the first wide portion 21.

The inner portion 32 is formed by a pair of opposite second arcuate groove wall portions 32a convex toward the opposite side to the center line 15c of the first sipe 15 so that the groove width continuously decreases inward in the tire radial direction to the bottom of the first wide portion 21.

Further, as shown in FIG. 4, in the present embodiment, the first wide portion 21 and the second wide portion 22 do not communicate with each other.

By adopting the above-described configuration, the tire 1 of the present embodiment can be improve in on-ice performance and loading durability while ensuring the mold releasability. The reason is as follows.

The first sipe 15 extends zigzag as described above. Further, the first sipe 15 is divided into the first portion 16 and the second portion 17 by the tie bar 18.

In such first sipe 15, when a load at the time of contacting with the ground acts on the first block 13, the sipe walls facing each other are strongly engaged with each other, and the rigidity of the first block 13 is maintained.

Further, the tie bars 18 helps to maintain the rigidity of the first block 13.

As a result, the collapse of the first block 13 is effectively suppressed; the strain at the sipe bottom of the first sipe 15 can be suppressed; and the loading durability is improved.

Further, as shown in FIG. 4, the first sipe 15 communicates with the first wide portion 21 and the second wide portion 22 which are not in communication with each other.

As a result, even if the first block 13 falls down, the strain is dispersed at the sipe bottom of the first sipe 15, and the damage can be suppressed.

Furthermore, since the first block 13 is prevented from collapsing by the mechanism described above, it is possible to ensure a large ground contact area when traveling on ice, and to obtain a large frictional force on ice due to the edge effect of the first sipe 15.

In addition, since the first sipe 15 communicates the first wide portion 21 and the second wide portion 22, the first sipe 15 exhibits excellent water absorption performance, which further enhances on-ice performance.

Furthermore, since the outer portion 31 is formed by the first arcuate groove wall portions 31a and the inner portion 32 is formed by the second arcuate groove wall portions 32a, the thick tip portion of a knife blade which forms the first wide portion 21 can be smoothly taken out from through the sipe during vulcanization molding, therefore, the mold releasability can be ensured.

For the above reasons, the tire 1 of the present embodiment can be improved in on-ice performance and loading durability while ensuring mold releasability.

A more detailed configuration of the present embodiment will be described below. Each configuration described below represents a specific aspect of the present embodiment. Therefore, the present disclosure can exhibit the above effects even if it does not have the configuration described below. Further, even if any one of the configurations described below is applied singly to the tire of the present disclosure having the features described above, an improvement in performance corresponding to each configuration can be expected. Furthermore, when some of the respective configurations described below are applied in combination, it is possible to expect a combined improvement in performance according to each configuration.

When the tread portion 2 is axially divided into four equal parts, namely, two axially outer parts 2A and two axially inner parts 2B, it is preferable that the above-described first blocks 13 disposed in the land portion 4 included in the axially outer parts 2A as shown in FIG. 1.

In the present embodiment, the first blocks 13 are disposed in the shoulder land portion 9 as the blocks 11 thereof, and the first blocks 13 forms the tread edges Te.

Thus, as the first sipes 15 are formed in the shoulder land portions 9 where the ground contact pressure tends to increase, the loading durability is reliably improved.

It is preferable that a plurality of the first sipes 15 are provided per first block 13 as shown in FIG. 3.

In the present embodiment, four first sipes 15 are provided per first block 13.

Each of the four first sipes 15 extends across the first block 13 in the tire axial direction. Further, in the present embodiment, except for the first sipes 15, no sipe or groove is provided in the first block 13.

However, the present disclosure is not limited to such example. For example, the first block 13 may be provided with a narrow grooves extending in the tire circumferential direction.

The interval “ta” between the circumferentially adjacent first sipes 15 (corresponds to the distance in the tire circumferential direction between the sipes' center lines) is, for example, set in a range from 3.0 to 7.0 mm, preferably from 4.0 to 6.0 mm.

Thereby, it is possible to exhibit excellent on-ice performance while suppressing uneven wear of the first blocks 13.

As shown in FIG. 5, the first sipe 15 extends in the tire radial direction with a constant width W2 in its cross section.

Further, as shown in FIG. 6, the first sipe 15 extends in its length direction with the constant width W2.

That is, the first sipe 15 in the present embodiment extends with the constant width W2 over its entirety.

For example, the width W2 is 1.0 mm or less, preferably 0.2 to 0.7 mm. Thereby, the loading durability and on-ice performance are improved in a well-balanced manner.

The present disclosure is however, not limited to such a dimension. The dimension may include inevitable errors in rubber products such as tires, therefore, in this context, the width of the first sipe 15 may vary depending on its measurement position.

Even in such case, however, it is preferable that the ratio W2M/W2m between the maximum value W2M and the minimum value W2m of the width of the first sipe 15 is 2.0 or less. The maximum value W2M is preferably 0.4 to 0.7 mm. The minimum value W2m is desirably 0.2 to 0.4 mm.

As shown in FIG. 7, the maximum depth d3 from the ground contacting top surface 13s of the first block 13 to the bottom of the first wide portion 21 is from 4.0 to 9.0 mm.

The maximum depth d4 from the ground contacting top surface 13s of the first block 13 to the bottom of the second wide portion 22 is from 4.0 to 9.0 mm.

Thereby, the loading durability and on-ice performance can be improved in a well-balanced manner.

In the present embodiment, as a preferable arrangement, the depth d3 and the depth d4 are the same.

The above-mentioned tie bar 18 is arranged, for example, in a central part when the first sipe 15 is divided into three equal parts in the sipe length direction.

In the present embodiment, as a preferable arrangement, the tie bar 18 is arranged so as to include the center position of the first sipe 15 in the longitudinal direction. Thereby, local deformation of the first sipe 15 is suppressed, and excellent loading durability is exhibited.

In the present embodiment, the tie bar 18 extends in the tire radial direction with a constant width, and a radially outer end 18a of the tie bar 18 has an arcuate outer surface which is convex toward the ground contacting top surface 13s of the first block 13.

In the cross section of the first sipe 15 along its length direction, the maximum width W5 of the tie bar 18 is, for example, in a range from 0.5 to 5.0 mm.

The height h1 from the bottom of the first wide portion 21 to the radially outer extreme end of the tie bar 18 is preferably not less than 30%, more preferably not less than 40%, but preferably not more than 80%, more preferably not more than 70% of the maximum depth d3 from the ground contacting top surface 13s of the first block 13 to the bottom of the first wide portion 21.

Such tie bars 18 serve to improve the loading durability and on-ice performance in a well-balanced manner.

As shown in FIG. 4, the first wide portion 21 extends linearly in the length direction of the first sipe 15 while maintaining the shape and area in the cross section of the first wide portion 21.

Thereby, except for the portion communicating with the first sipe 15, the first wide portion 21 has a columnar shape extending in the length direction of the sipe with a constant cross-sectional shape.

The central axis of the first wide portion 21, which can be defined by a set of centroids of the cross sectional shapes of the first wide portion 21 at positions along the length thereof, extends linearly.

As shown in FIG. 5, the maximum width L1 in the cross section of the first wide portion 21 is preferably not less than 2.0 times, more preferably not less than 3.0 times, but preferably not more than 6.0 times, more preferably not more than 5.0 times the width of the first sipe 15 in the cross section.

Thereby, the above-described effects can be obtained while demonstrating excellent mold releasability during tire production.

Here, the width of the first sipe 15 in the cross section means the constant width W2 in the present embodiment, and when the width varies depending on the measurement position, it means the maximum width.

It is preferable that, in the first wide portion 21, as shown in FIG. 8, the curvature radius r1 of the first arcuate groove wall portions 31a is larger than the curvature radius r2 of the second arcuate groove wall portions 32a.

The curvature radius r1 is preferably not more than 5.0 times the curvature radius r2. the curvature radius r2 is preferably 1.2 to 2.0 times the width between the two inner walls of the sipe. This will reliably improve the mold releasability.

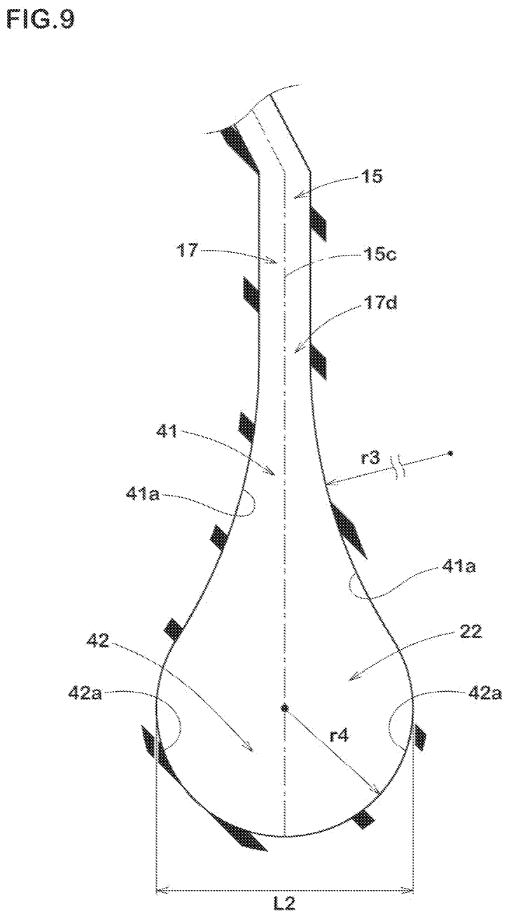

FIG. 9 is an enlarged cross-sectional view of the second wide portion 22 corresponding to the cross-sectional view taken along line CC in FIG. 3.

As shown, the second wide portion 22 comprises a radially outer portion 41 and a radially inner portion 42.

In the cross-sectional view of the second wide portion 22, the outer portion 41 is formed by a pair of opposite first arcuate groove wall portions 41a each convex toward the sipe center line 15c of the first sipe 15, so that the groove width increases continuously and inwardly in the tire radial direction from the sipe bottom 17d in the second portion 17.

The inner portion 42 is formed by a pair of opposite second arcuate groove wall portions 42a each convex toward the opposite side to the sipe center line 15c of the first sipe 15 so that the groove width decreases continuously toward the radially inside. Thereby, the thick tip end portion of the knife blade forming the second wide portion 22 can be smoothly taken out from through the sipe, and the mold releasability can be ensured more reliably.

The second wide portion 22 has the same configuration as the first wide portion 21. That is, the above-described configuration of the first wide portion 21 can also be applied to the second wide portion 22.

Therefore, as shown in FIG. 4, the second wide portion 22 extends linearly along the length direction of the second portion 17 over its entire length.

Further, as shown in FIG. 9, in the second wide portion 22, the curvature radius r3 of the first arcuate groove wall portions 41a is larger than the curvature radius r4 of the second arcuate groove wall portions 42a.

The curvature radius r1 of the first wide portion 21 described above can be applied to the curvature radius r3.

The curvature radius r2 of the first wide portion 21 described above can be applied to the curvature radius r4.

Therefore, description of the numerical ranges for the curvature radii r3 and r4 is omitted.

The maximum width L2 of the second wide portion 22 in its cross section is preferably not less than 2.0 times, more preferably not less than 3.0 times, but preferably not more than 6.0 times, more preferably not more than 5.0 times the width of the first sipe 15 in its cross section.

As shown in FIG. 4, the ratio V1/V2 between the volume V1 of the first wide portion 21 and the volume V2 of the second wide portion 22 is about 0.8 to 1.2. Namely, these volumes are substantially the same.

As a modified example, it may be possible that the first wide portion 21 is arranged on the tread edge Te side of the second wide portion 22, and the volume V1 of such axially outer first wide portion 21 is larger than the volume V2 of the axially inner second wide portion 22.

In this case, the volume V1 is preferably set in a range from 120% to 150% of the volume V2.

In this example, since the first wide portion 21 arranged near the tread edge Te can exhibit excellent water absorbency, it is possible to focus on improving the on-ice performance. Further, an improvement in wandering performance can be expected.

As still another example, it may be possible that the first wide portion 21 is arranged on the tread edge Te side of the second wide portion 22, and the volume V1 of such axially outer first wide portion 21 is smaller than the volume V2 of the axially inner second wide portion 22.

In this case, the volume V1 is preferably set in a range from 50% to 80% of the volume V2.

In this example, since the volume of the first wide portion 21 arranged near the tread edge Te is small, uneven wear near the tread edge Te can be suppressed.

In the present embodiment, as shown in FIG. 2, the tread portion 2 comprises a cap tread rubber layer Cg and a base tread rubber layer Bg.

The cap tread rubber layer Cg forms the ground contacting surface of the tread portion 2.

The base tread rubber layer Bg is arranged radially inside the cap tread rubber layer Cg.

The cap tread rubber layer Cg has a rubber hardness in a range from 40 to 65 degrees, for example.

The base tread rubber layer Bg has a rubber hardness larger than that of the cap tread rubber layer Cg.

The rubber hardness of the base tread rubber layer Bg is, for example, in a range from 50 to 75 degrees.

In this application, the rubber hardness means a type-A durometer hardness measured at 23 degrees C. according to JIS-K6253.

In the present embodiment, the distance t2 from the ground contacting surface of the tread portion 2 to the boundary 25 between the cap tread rubber layer Cg and the base tread rubber layer Bg is in a range from 30% to 70% of the total thickness 11 of the cap tread rubber layer Cg and the base tread rubber layer Bg.

As shown in FIG. 5, a minimum distance t3 in the tire radial direction from the boundary 25 to the bottoms of the first wide portion 21 and the second wide portion 22 is not less than 0.5 mm, preferably not less than 1.0 mm and not more than 4.0 mm.

Thereby, the rubber separation at the boundary 25 due to deformation of the first wide portion 21 and the second wide portion 22, can be effectively suppressed.

While detailed description has been made of a preferable embodiment of the present disclosure, the present disclosure can be embodied in various forms without being limited to the illustrated embodiment.

### STATEMENT OF THE PRESENT DISCLOSURE

The present disclosure is as follows:

### [Present Disclosure 1]

A tire comprising a tread portion provided with a plurality of circumferential grooves extending continuously in a tire circumferential direction, a plurality of lateral grooves extending in a tire axial direction, and a plurality of first blocks,

wherein
each of the first blocks is provide with at least one first sipe which extends zigzag in a cross section perpendicular to the length direction thereof, and extends zigzag in a cross section parallel with the ground contacting top surface of the first block,
each of the first sipes is provided with at least one tie bar which is locally raised outward in a tire radial direction from the sipe bottom, and terminated without reaching the ground contacting top surface of the first block so that the first sipe is partially divided in the length direction of the sipe by the above-said at least one tie bar into at least a first portion and a second portion,
in each of the first sipes, the sipe bottom of the first portion communicates with a first wide portion having a groove width larger than the sipe width of the first portion, and the sipe bottom of the second portion communicates with a second wide portion having a groove width larger than the sipe width of the second portion,
the above-said first wide portion comprises, in its cross section, an outer portion in the tire radial direction formed by a pair of first arcuate groove wall portions each convex toward a center line of the first sipe so that the groove width continuously increases from the sipe bottom toward the inner side in the tire radial direction, and an inner portion in the tire radial direction formed by a pair of second arcuate groove wall portions each convex toward the opposite side to the center line of the first sipe so that the groove width continuously decreases inward in the tire radial direction to the bottom of the first wide portion, and
the first wide portion and the second wide portion do not communicate with each other.

### [Present Disclosure 2]

The tire according to Present Disclosure 1, wherein the first wide portion extends linearly along the length direction of the first portion over its entire length.

### [Present Disclosure 3]

The tire according to Present Disclosure 1 or 2, wherein the curvature radius of the first arcuate groove wall portion is larger than the curvature radius of the second arcuate groove wall portion.

### [Present Disclosure 4]

The tire according to Present Disclosure 1, 2 or 3, wherein the second wide portion comprises a radially outer portion and a radially inner portion, and
in a cross section of the second wide portion, the radially outer portion is formed by a pair of opposite first arcuate groove wall portions each convex toward a center line of the first sipe, so that the second wide portion has a groove width continuously increasing from the bottom of the first sipe toward the inside in the tire radial direction, the radially inner portion is formed by a pair of opposite second arcuate groove wall portions each convex toward the opposite side to the center line of the first sipe, so that the second wide portion has a groove width continuously decreasing toward a bottom of the second wide portion.

### [Present Disclosure 5]

The tire according to Present Disclosure 4, wherein the second wide portion extends linearly along the length direction of the first sipe in the second portion over its entire length.

### [Present Disclosure 6]

The tire according to Present Disclosure 4, wherein in the second wide portion, the curvature radius of the first arcuate groove wall portions is larger than the curvature radius of the second arcuate groove wall portions.

### [Present Disclosure 7]

The tire according to any one of Present Disclosures 1 to 6, wherein the maximum width of the first wide portion in its cross section is 2.0 to 6.0 times the width of the first sipe in its cross section.

### [Present Disclosure 8]

The tire according to any one of Present Disclosures 1 to 7, wherein the maximum width of the second wide portion in its cross section is 2.0 to 6.0 times the width of the first sipe in its cross section.

### [Present Disclosure 9]

The tire according to any one of Present Disclosures 1 to 8, wherein the plurality of first blocks constitutes tread edges of the tread portion.

### [Present Disclosure 10]

The tire according to any one of Present Disclosures 1 to 9, wherein a height in the tire radial direction from the bottom of the first wide portion to a radially outer end of the tie bar is 30% to 80% of a maximum depth from the ground contacting top surface of the first block to the bottom of the first wide portion.

### [Present Disclosure 11]

The tire according to any one of Present Disclosures 1 to 10, wherein a width of the tie bar in a cross section along the length direction of the first sipe is 0.5 to 5.0 mm.

### DESCRIPTION OF THE REFERENCE SIGNS

2 tread portion
3 circumferential groove
10 lateral groove
13 first block
15 first sipe
16 first portion
16d sipe bottom in first portion
17 second portion
17d sipe bottom in second portion
18 tie bar
21 first wide portion
22 second wide portion
31 radially outer portion
31a first arcuate groove wall portion
32 radially inner portion
32a second arcuate groove wall portion

1. A tire comprising a tread portion provided with
a plurality of circumferential grooves extending continuously in a tire circumferential direction,
a plurality of lateral grooves extending in a tire axial direction, and
a plurality of first blocks,
wherein
each of the first blocks is provide with at least one first sipe which extends zigzag in a cross section perpendicular to the length direction thereof, and extends zigzag in a cross section parallel with the ground contacting top surface of the first block,
each of the first sipes is provided with at least one tie bar which is locally raised outward in a tire radial direction from the sipe bottom, and terminated without reaching the ground contacting top surface of the first block so that the first sipe is partially divided in the length direction of the sipe by the above-said at least one tie bar into at least a first portion and a second portion,
in each of the first sipes, the sipe bottom of the first portion communicates with a first wide portion having a groove width larger than the sipe width of the first portion, and the sipe bottom of the second portion communicates with a second wide portion having a groove width larger than the sipe width of the second portion,
the above-said first wide portion comprises, in its cross section,
an outer portion in the tire radial direction formed by a pair of first arcuate groove wall portions each convex toward a center line of the first sipe so that the groove width continuously increases from the sipe bottom toward the inner side in the tire radial direction, and
an inner portion in the tire radial direction formed by a pair of second arcuate groove wall portions each convex toward the opposite side to the center line of the first sipe so that the groove width continuously decreases inward in the tire radial direction to the bottom of the first wide portion, and
the first wide portion and the second wide portion do not communicate with each other.

2. The tire according to claim 1, wherein
the first wide portion extends linearly along the length direction of the first portion over its entire length.

3. The tire according to claim 1, wherein
the curvature radius of the first arcuate groove wall portion is larger than the curvature radius of the second arcuate groove wall portion.

4. The tire according to claim 2, wherein
the curvature radius of the first arcuate groove wall portion is larger than the curvature radius of the second arcuate groove wall portion.

5. The tire according to claim 1, wherein
the second wide portion comprises a radially outer portion and a radially inner portion,
in a cross section of the second wide portion, the radially outer portion is formed by a pair of opposite first arcuate groove wall portions each convex toward a center line of the first sipe, so that the second wide portion has a groove width continuously increasing from the bottom of the first sipe toward the inside in the tire radial direction, and
the radially inner portion is formed by a pair of opposite second arcuate groove wall portions each convex toward the opposite side to the center line of the first sipe, so that the second wide portion has a groove width continuously decreasing toward a bottom of the second wide portion.

6. The tire according to claim 2, wherein
the second wide portion comprises a radially outer portion and a radially inner portion,
in a cross section of the second wide portion, the radially outer portion is formed by a pair of opposite first arcuate groove wall portions each convex toward a center line of the first sipe, so that the second wide portion has a groove width continuously increasing from the bottom of the first sipe toward the inside in the tire radial direction, and
the radially inner portion is formed by a pair of opposite second arcuate groove wall portions each convex toward the opposite side to the center line of the first sipe, so that the second wide portion has a groove width continuously decreasing toward a bottom of the second wide portion.

7. The tire according to claim 3, wherein
the second wide portion comprises a radially outer portion and a radially inner portion,
in a cross section of the second wide portion, the radially outer portion is formed by a pair of opposite first arcuate groove wall portions each convex toward a center line of the first sipe, so that the second wide portion has a groove width continuously increasing from the bottom of the first sipe toward the inside in the tire radial direction, and
the radially inner portion is formed by a pair of opposite second arcuate groove wall portions each convex toward the opposite side to the center line of the first sipe, so that the second wide portion has a groove width continuously decreasing toward a bottom of the second wide portion.

8. The tire according to claim 4, wherein
the second wide portion comprises a radially outer portion and a radially inner portion,
in a cross section of the second wide portion, the radially outer portion is formed by a pair of opposite first arcuate groove wall portions each convex toward a center line of the first sipe, so that the second wide portion has a groove width continuously increasing from the bottom of the first sipe toward the inside in the tire radial direction, and
the radially inner portion is formed by a pair of opposite second arcuate groove wall portions each convex toward the opposite side to the center line of the first sipe, so that the second wide portion has a groove width continuously decreasing toward a bottom of the second wide portion.

9. The tire according to claim 5, wherein
the second wide portion extends linearly along the length direction of the first sipe in the second portion over its entire length.

10. The tire according to claim 5, wherein
in the second wide portion, the curvature radius of the first arcuate groove wall portions is larger than the curvature radius of the second arcuate groove wall portions.

11. The tire according to claim 1, wherein
the maximum width of the first wide portion in its cross section is 2.0 to 6.0 times the width of the first sipe in its cross section.

12. The tire according to of claim 1, wherein
the maximum width of the second wide portion in its cross section is 2.0 to 6.0 times the width of the first sipe in its cross section.

13. The tire according to claim 1, wherein
the plurality of first blocks constitutes tread edges of the tread portion.

14. The tire according to claim 1, wherein
a height in the tire radial direction from the bottom of the first wide portion to a radially outer end of the tie bar is 30% to 80% of a maximum depth from the ground contacting top surface of the first block to the bottom of the first wide portion.

15. The tire according to claim 1, wherein
a width of the tie bar in a cross section along the length direction of the first sipe is 0.5 to 5.0 mm.
